(19) United States
(12) Patent Application Publication
(10) Pub. No.: US 2010/0046122 A1
(43) Pub. Date: Feb. 25, 2010

(54) Fault protection device

(76) Inventors: Ching-Feng Cheng, Taipei (TW); Jiin-Cheng Jow, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/314,028

(22) Filed: Dec. 3, 2008

(30) Foreign Application Priority Data
Aug. 19, 2008 (CN) 200810135503.4

(51) Int. Cl. H02H 7/16

(52) U.S. Cl. 361/15

(57) ABSTRACT

A fault protection device includes a magnetic capacitor unit and an isolation switch. The magnetic capacitor unit is capable of storing electrical energy, and has a first end and a second end. The isolation switch is capable of being switched on to electrically connect the first end of the magnetic capacitor unit to the second end of the magnetic capacitor unit for forming a short-circuit path between the first and second ends of the magnetic capacitor unit when the magnetic capacitor unit breaks down.

### CROSS-REFERENCE TO RELATED APPLICATION

This application claims priority of Chinese Application No. 200810135503.4, filed on Aug. 19, 2008.

### BACKGROUND OF THE INVENTION

1. Field of the Invention

The invention relates to a fault protection device, more particularly to a fault protection device capable of isolating a magnetic capacitor unit that has broken down.

2. Description of the Related Art

Batteries, capacitors, super capacitors, etc., are widely used as energy storage components. While capacitors are relatively simple to fabricate, they are only suitable for short-term energy storage due to their small storage capacity. On the other hand, since batteries primarily apply a chemical-based mechanism for energy storage, the energy storage density thereof is evidently superior to that of conventional capacitors. Batteries can thus be applied to different types of power supplying devices. However, since the instantaneous power output generated by a battery is limited by the chemical reaction speed, rapid charging/discharging and high-power output are not possible. In addition, the permitted number of charging/discharging times is limited as well, i.e., various problems easily arise when a battery is overly charged/discharged.

A super capacitor is a component falling between a battery and a capacitor, and is also called an electrical double-layer capacitor. Since a super capacitor has a structure of part physical-based energy storage and part chemical-based energy storage, the super capacitor has a larger capacity than an ordinary capacitor. Nevertheless, due to the chemical characteristics of the chemical materials used therein, the super capacitor is susceptible of current leakage as in a conventional battery. On the other hand, due to the physical characteristics of the physical materials used therein, the super capacitor is prone to discharge very rapidly, which is not good for effective energy storage. Moreover, the voltage resistance of the super capacitor is not high, and the internal resistance thereof is relatively large, making the super capacitor unsuited for use in alternating current circuits. Furthermore, leakage of electrolyte can occur when the super capacitor is not used properly.

In sum, the aforementioned conventional energy storage components do not simultaneously possess the following advantages: long service life (high permitted number of charging/discharging times), high-energy storage density, high instantaneous power output, and rapid charging/discharging. Therefore, there is a need in the art to provide an energy storage device with the above advantages for application to electronic devices that are normally equipped with a battery or a capacitor as an energy storage component.

### SUMMARY OF THE INVENTION

Therefore, the object of the present invention is to provide a fault protection device capable of isolating a magnetic capacitor unit that has broken down so as to protect other circuit components.

According to one aspect of this invention, a fault protection device includes a magnetic capacitor unit and an isolation switch. The magnetic capacitor unit is capable of storing electrical energy, and has a first end and a second end. The isolation switch is capable of being switched on to electrically connect the first end of the magnetic capacitor unit to the second end of the magnetic capacitor unit for forming a short-circuit path between the first and second ends of the magnetic capacitor unit when the magnetic capacitor unit breaks down.

According to another aspect of this invention, a fault protection device includes a magnetic capacitor unit and an isolation switch. The magnetic capacitor unit is capable of storing electrical energy, and has a first end and a second end. The isolation switch is capable of being switched on to electrically connect the first end of the magnetic capacitor unit to the second end of the magnetic capacitor unit. The isolation switch is switched off when the fault protection device operates in a testing mode in which the first and second ends of the magnetic capacitor unit receive a testing signal for testing breakdown of the magnetic capacitor unit.

Preferably, the magnetic capacitor unit includes at least one magnetic capacitor having a first magnetic electrode, a second magnetic electrode, and a dielectric layer disposed between the first and second magnetic electrodes. The first and second magnetic electrodes are magnetized to have magnetic dipoles arranged in such a manner to reduce current leakage of the magnetic capacitor unit.

Preferably, at least one of the first and second magnetic electrodes includes a first magnetic layer, a second magnetic layer, and an insulator layer made of a non-magnetic material and disposed between the first and second magnetic layers.

Preferably, each of the first and second magnetic electrodes contains a rare earth element, and the dielectric layer contains titanium oxide, barium titanate, or a semiconductor material (for example, silicon oxide).

### BRIEF DESCRIPTION OF THE DRAWINGS

Other features and advantages of the present invention will become apparent in the following detailed description of the preferred embodiments with reference to the accompanying drawings, of which:

FIG. 1 is a circuit diagram illustrating a first preferred embodiment of a fault protection device according to this invention;

FIG. 2 is a graph to compare performance of a magnetic capacitor in the preferred embodiment with other conventional energy storage media;

FIG. 3 is a schematic diagram showing a magnetic capacitor used as a magnetic capacitor unit in the preferred embodiment;

FIG. 4 is a schematic diagram showing a first magnetic electrode of another magnetic capacitor useful as the magnetic capacitor unit in the preferred embodiment;

FIG. 5 is a schematic diagram of a magnetic capacitor bank useful as the magnetic capacitor unit in the preferred embodiment;

FIG. 6 is a circuit diagram illustrating the configuration of the first preferred embodiment when operating in a working mode;

FIG. 7 is a circuit diagram illustrating how a magnetic capacitor unit that has broken down is isolated when the first preferred embodiment is operated in the working mode;

FIG. 8 is a circuit diagram illustrating a second preferred embodiment of a fault protection device according to this invention;

FIG. 9 is a circuit diagram illustrating how a magnetic capacitor unit that has broken down is isolated when the second preferred embodiment is operated in the working mode; and

FIG. 10 is a circuit diagram illustrating a third preferred embodiment of a fault protection device according to this invention.

### DETAILED DESCRIPTION OF THE PREFERRED EMBODIMENTS

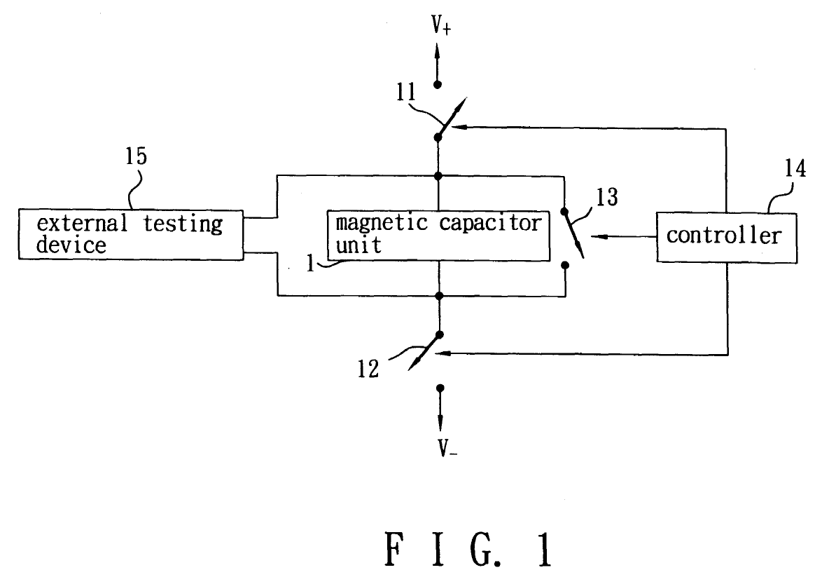

Referring to FIG. 1, the first preferred embodiment of a fault protection device according to this invention is shown to includes a magnetic capacitor unit 1, a first switch 11, a second switch 12, an isolation switch 13, and a controller 14. It should be noted that the switches 11, 12, 13 can be of the same type or different types. Furthermore, the switches 11, 12, 13 can be made via a semiconductor fabrication process when the magnetic capacitor unit 1 is made via a semiconductor fabrication process.

The magnetic capacitor unit may be a single magnetic capacitor or a magnetic capacitor bank formed from a plurality of magnetic capacitors that are connected in series and/or in parallel. In this embodiment, the magnetic capacitor is a silicon semiconductor component, which is capable of realizing high density and large energy storage capacity through a physical-based energy storing mechanism under a specified magnetic field. The magnetic capacitor has characteristics of large output current, small size, light weight, long service life, excellent charge/discharge capability, no charging memory effect, etc. Hence, when the magnetic capacitor is used as an energy storage component to replace conventional batteries, capacitors, super capacitors, etc., aside from reducing the size, weight and manufacturing cost of the energy storage device, the service life of the energy storage device can be lengthened as well.

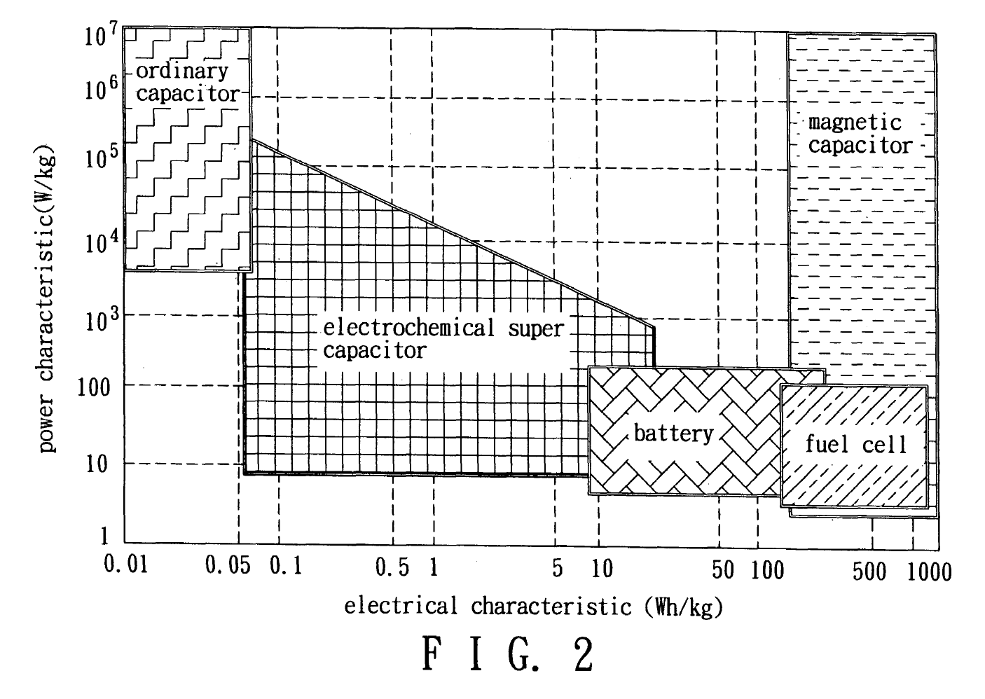

Referring to FIG. 2, since conventional energy storage media (such as conventional batteries and super capacitors) mainly use a chemical-based energy storage mechanism, the energy storage densities thereof are better than those of ordinary capacitors. Conventional batteries and super capacitors are thus applicable to different power supplying devices. However, since the instantaneous power output is limited by the chemical reaction speed, rapid charging/discharging and high-power output are not possible. In addition, the permitted number of charging/discharging times is limited as well, i.e., various problems easily arise in case the energy storage medium is overly charged/discharged.

In contrast, since energy stored in the magnetic capacitor is in a form of potential energy, therefore, apart from having an energy storage density comparable to conventional batteries and super capacitors, the magnetic capacitor retains characteristics of ordinary capacitors and thus has advantages of long service life (high permitted number of charging/discharging times), no charging memory effect, high power output, rapid charging/discharging, etc. The magnetic capacitor can thus effectively overcome the aforementioned disadvantages of conventional batteries.

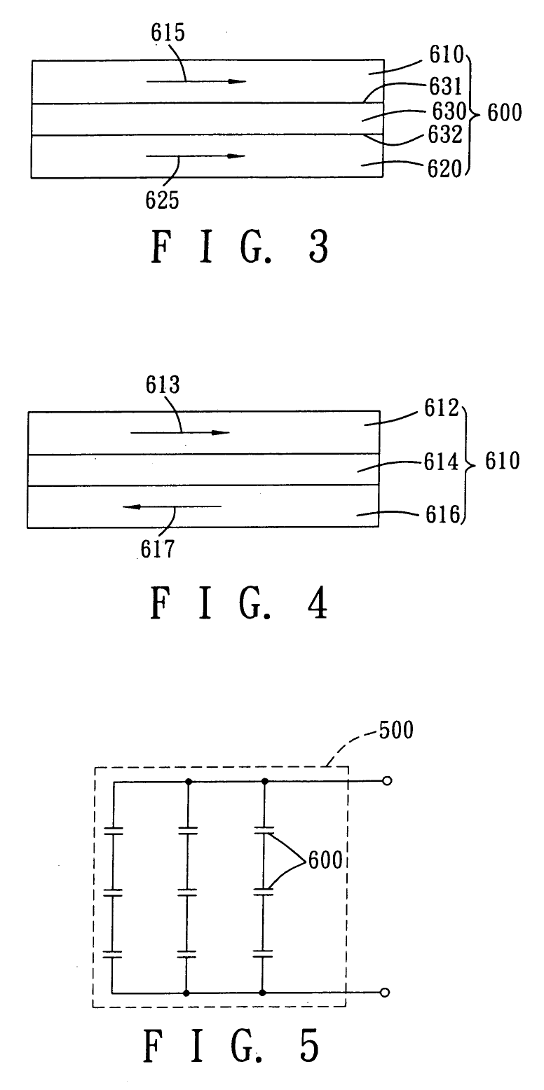

Referring to FIG. 3, a magnetic capacitor 600 useful in the magnetic capacitor unit 1 in the preferred embodiment is shown to include a first magnetic electrode 610, a second magnetic electrode 620, and a dielectric layer 630 disposed between the first and second magnetic electrodes 610, 620. The first and second magnetic electrodes 610, 620 are made of an electrically conductive magnetic material and are magnetized through application of a suitable external electric field to have magnetic dipoles 615, 625. The magnetic dipoles 615, 625 are arranged in such a manner to form a magnetic field inside the magnetic capacitor 600 that can affect movement of charged particles to thereby reduce current leakage of the magnetic capacitor 600.

It is noted that the directions of the arrows that stand for the magnetic dipoles 615, 625 in FIG. 3 are solely for illustrative purpose. Those skilled in the art may readily appreciate that the magnetic dipoles 615, 625 are actually formed from a plurality of aligned tiny dipoles. Moreover, in this invention, the actual directions of the resultant magnetic dipoles 615, 625 are not limited, i.e., the magnetic dipoles 615, 625 may have the same direction or different directions. The dielectric layer 630 is used to separate the first and second magnetic electrodes 610, 620 from each other and to accumulate charges at the first and second magnetic electrodes 610, 620 for storing potential energy. In an embodiment of this invention, each of the first magnetic electrode 610 and the second magnetic electrode 620 contains an electrically conductive magnetic material, such as a rare earth element, and the dielectric layer 630 contains one of titanium oxide (TiO₃), barium titanate (BaTiO₃), and a semiconductor layer, such as silicon oxide. However, the present invention is not limited in this aspect, and other materials may be employed for the first magnetic electrode 610, the second magnetic electrode 620 and the dielectric layer 630 to meet product requirements.

The operating principle of the magnetic capacitor is further described as follows. The phenomenon where resistance of matter changes under a specified magnetic field is called magneto resistance. Magnetic metal and alloy materials generally exhibit the phenomenon of magneto resistance. Under normal conditions, the resistance of matter is only slightly reduced in a magnetic field. However, when certain conditions are met, the magnitude of reduction in the resistance will be rather significant, and will be more than 10 times the magneto resistance values of magnetic metal and alloy materials. This is known as giant magneto resistance (GMR). If further combined with the Maxwell-Wagner circuit model, magnetic granular composite media are able to generate the so-called colossal magneto capacitance (CMC) or giant magneto capacitance (GMC).

In a conventional capacitor, the capacitance (C) is determined by the area (A) of the capacitor, the dielectric constants (ε₀, εᵣ) of the dielectric layer, and the thickness (d), as shown in the equation below.

$$C = \frac{{ɛ}_{0} {ɛ}_{r} A}{d}$$

However, in this invention, the magnetic capacitor 600 utilizes the aligned magnetic dipoles in the first and second magnetic electrodes 610, 620 to form a magnetic field so that electrons stored therein self-rotate in a same direction for tidy arrangement. As a result, the magnetic capacitor 600 is able to accommodate more charges under the same conditions and thereby increase the energy storage density. The operating principle of the magnetic capacitor 600 is thus equivalent to changing the dielectric constant of the dielectric layer 630 through the magnetic field so as to result in a significant increase in capacitance.

Moreover, in this embodiment, each of an interface 631 between the first magnetic electrode 610 and the dielectric layer 630 and an interface 632 between the second magnetic electrode 620 and the dielectric layer 630 is an uneven surface, thereby increasing the area (A) to further increase the capacitance (C) of the magnetic capacitor 600.

FIG. 4 shows a first magnetic electrode 610 of another magnetic capacitor useful as the magnetic capacitor unit 1 in the preferred embodiment. The first magnetic electrode 610 has a multi-layer structure, and includes a first magnetic layer 612, an insulator layer 614 and a second magnetic layer 616. The insulator layer 614 is made of a non-magnetic material. Each of the first magnetic layer 612 and the second magnetic layer 616 is made of an electrically conductive magnetic material. When magnetized, the magnetic dipoles 613, 617 of the first and second magnetic layers 612, 614 have different directions due to different external electric fields. In this embodiment, the directions of the magnetic dipoles 613, 617 are opposite to each other so as to further reduce current leakage of the magnetic capacitor 600.

The structure of the first magnetic electrode 610 is not limited to the aforementioned three-layer structure. By interleaving magnetic layers and non-magnetic layers, followed by adjusting the direction of magnetic dipoles in each magnetic layer, the effect of reducing current leakage of the magnetic capacitor 600 to a minimum can be achieved.

Moreover, since conventional energy storage components employ a chemical-based mechanism for energy storage, they must be of a certain size in order to prevent a large drop in efficiency. In contrast, the magnetic capacitor 600 of this invention stores energy in the form of potential energy. In addition, the materials used to make the magnetic capacitor 600 are adapted for semiconductor fabrication. Accordingly, an appropriate semiconductor fabrication process can be employed to form the magnetic capacitor 600 and to connect the same to a peripheral circuit, thus reducing the size and weight of the magnetic capacitor 600. Since conventional semiconductor fabrication techniques, which are known to those skilled in the art, are employed to form the magnetic capacitor 600, further details of the fabrication techniques will be omitted herein for the sake of brevity.

FIG. 5 illustrates a magnetic capacitor bank 500 useful as the magnetic capacitor unit 1 in the preferred embodiment. From the foregoing, by employing an appropriate semiconductor fabrication process to fabricate a plurality of small-sized magnetic capacitors 600 on a silicon substrate, followed by an appropriate metallization process to form electrical connections among the magnetic capacitors 600, the magnetic capacitor bank 500 that includes a plurality of the magnetic capacitors 600 is formed and can be used as an energy storage device or a power supply source of an external apparatus. The magnetic capacitors 600 in the magnetic capacitor bank 500 are interconnected electrically in a matrix layout. However, the present invention is not limited in this respect. Depending on different voltage or capacitance requirements, the magnetic capacitors 600 may be interconnected in series and/or in parallel so as to satisfy power supply requirements of various apparatuses.

Referring again to FIG. 1, the magnetic capacitor unit 1 is capable of storing electrical energy, and has a first end and a second end. The first switch 11 is capable of being switched on to electrically connect the first end of the magnetic capacitor unit 1 to a first node, and the first node receives a voltage (V+). The second switch 12 is capable of being switched on to electrically connect the second end of the magnetic capacitor unit 1 to a second node, and the second node receives a voltage (V−). The isolation switch 13 is capable of being switched on to electrically connect the first end of the magnetic capacitor unit 1 to the second end of the magnetic capacitor unit 1. The controller 14 controls the switching of the first switch 11, the second switch 12, and the isolation switch 13.

When the fault protection device operates in a testing mode, the isolation switch 13, the first switch 11, and the second switch 12 are controlled by the controller 14 to be switched off. In the testing mode, the first and second ends of the magnetic capacitor unit 1 are connected to an external testing device 15 (for example, an automatic test equipment or a BIST (built-in self-test) circuit) so as to receive a testing signal for testing breakdown of the magnetic capacitor unit 1. A reference voltage used as the testing signal is applied from the external testing device 15 to the magnetic capacitor unit 1. After a charging period sufficient for complete charging of the magnetic capacitor unit 1, a charging voltage of the magnetic capacitor unit 1 is compared to the reference voltage to determine whether or not the magnetic capacitor unit 1 has broken down. That is, the magnetic capacitor unit 1 has not yet broken down when the charging voltage is substantially equal to or is within a tolerable range of the reference voltage. Otherwise, the magnetic capacitor unit 1 is deemed to have broken down.

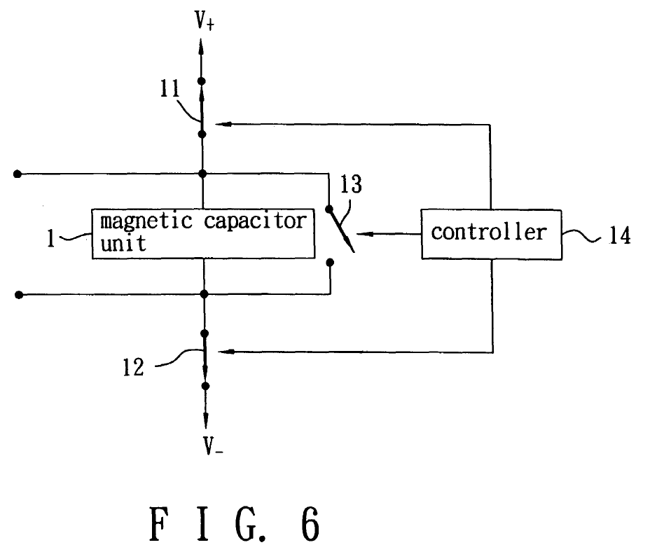

Referring to FIG. 6, when the magnetic capacitor unit 1 has yet to break down while the fault protection device operates in a working mode, the first switch 11, the second switch 12, and the isolation switch 13 are controlled by the controller 14 so that the first switch 11 and the second switch 12 are switched on and the isolation switch 13 is switched off to enable operation of the magnetic capacitor unit 1.

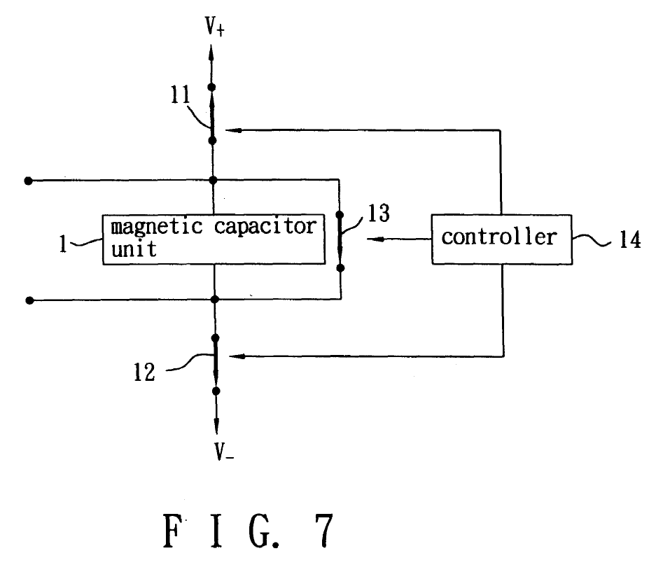

Referring to FIG. 7, when the magnetic capacitor unit 1 breaks down while the fault protection device operates in the working mode, the first switch 11, the second switch 12, and the isolation switch 13 are controlled by the controller 14 so that the first switch 11, the second switch 12, and the isolation switch 13 are switched on. At this time, the isolation switch 13 electrically connects the first end of the magnetic capacitor unit 1 to the second end of the magnetic capacitor unit 1 to form a short-circuit path between the first and second ends of the magnetic capacitor unit 1. Therefore, the magnetic capacitor unit 1 in a broken-down state can be electrically isolated when it is used along with other circuit components.

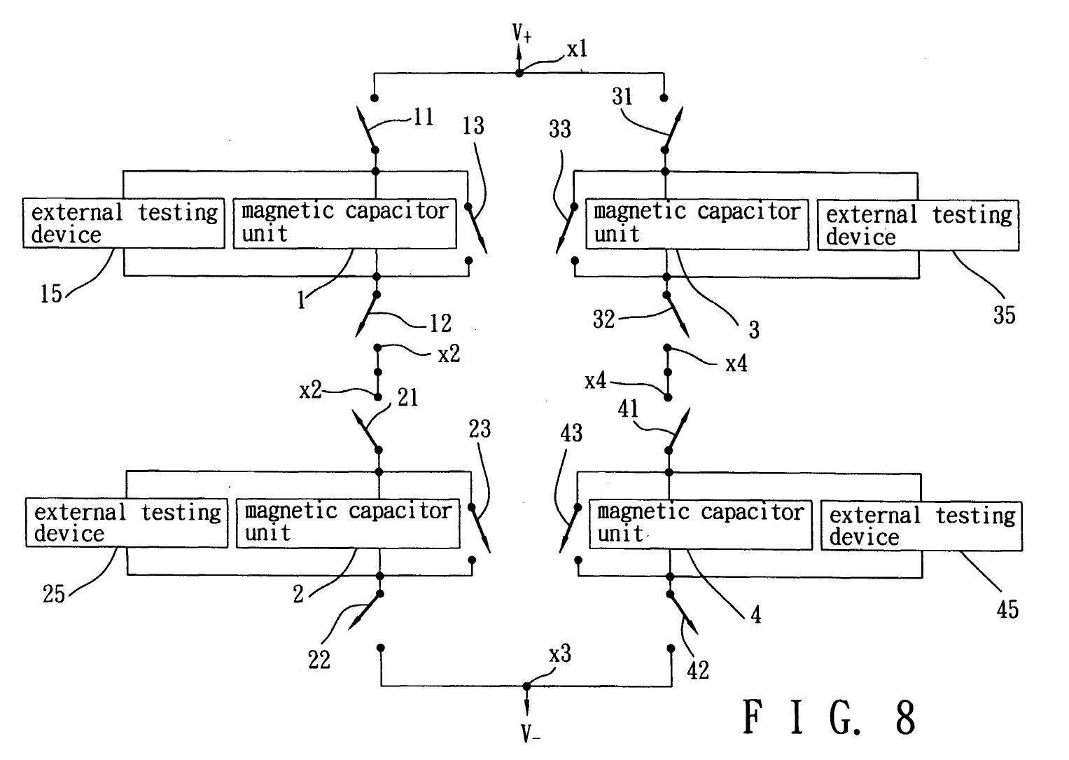

Referring to FIG. 8, the second preferred embodiment of a fault protection device according to this invention is shown to include four magnetic capacitor units 1, 2, 3, 4, four first switches 11, 21, 31, 41, four second switches 12, 22, 32, 42, four isolation switches 13, 23, 33, 43, and a controller (not shown).

The isolation switches 13, 23, 33, 43 are capable of being switched on to electrically connect the first ends of the magnetic capacitor units 1, 2, 3, 4 to the second ends of the magnetic capacitor units 1, 2, 3, 4 correspondingly. The first switches 11, 31 are capable of being switched on to electrically connect the first ends of the magnetic capacitor units 1, 3 to a node (X1). The first switch 21 is capable of being switched on to electrically connect the first end of the magnetic capacitor unit 2 to a node (X2). The second switch 12 is capable of being switched on to electrically connect the second end of the magnetic capacitor unit 1 to the node (X2). The second switches 22, 42 are capable of being switched on to electrically connect the second ends of the magnetic capacitor units 2, 4 to a node (X3). The second switch 32 is capable of being switched on to electrically connect the second end of the magnetic capacitor unit 3 to a node (X4). The first switch 41 is capable of being switched on to electrically connect the first end of the magnetic capacitor unit 4 to a node (X4). In addition, the node (X1) receives a voltage (V+), and the node (X3) receives a voltage (V−).

When the fault protection device operates in a testing mode, the isolation switches 13, 23, 33, 43, the first switches 11, 21, 31, 41, and the second switches 12, 22, 32, 42 are controlled by the controller to be switched off. In the testing mode, the first and second ends of the magnetic capacitor units 1, 2, 3, 4 are connected to external testing devices 15, 25, 35, 45 so as to receive a testing signal for testing breakdown of the magnetic capacitor units 1, 2, 3, 4.

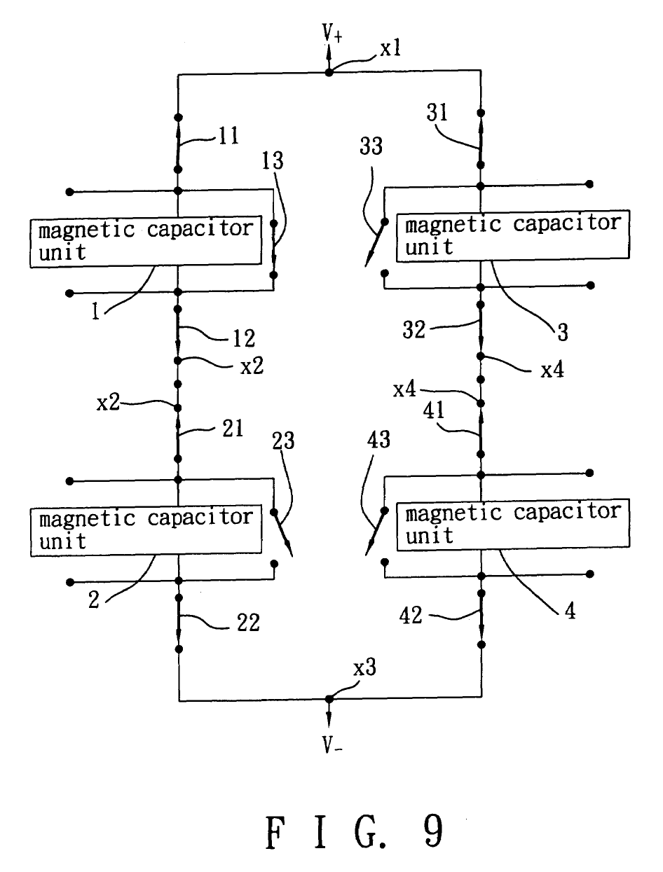

Referring to FIG. 9, when the magnetic capacitor unit 1 was tested to have broken down, while the fault protection device operates in a working mode, the first switch 11, the second switch 12, and the isolation switch 13 are controlled by the controller so that the first switch 11, the second switch 12, and the isolation switch 13 are switched on. At this time, the isolation switch 13 electrically connects the first end of the magnetic capacitor unit 1 to the second end of the magnetic capacitor unit 1 to form a short-circuit path between the first and second ends of the magnetic capacitor unit 1. Therefore, the magnetic capacitor unit 1 in a broken-down state can be electrically isolated from the magnetic capacitors 2, 3, 4 so that the magnetic capacitors 2, 3, 4 still operate normally in the working mode.

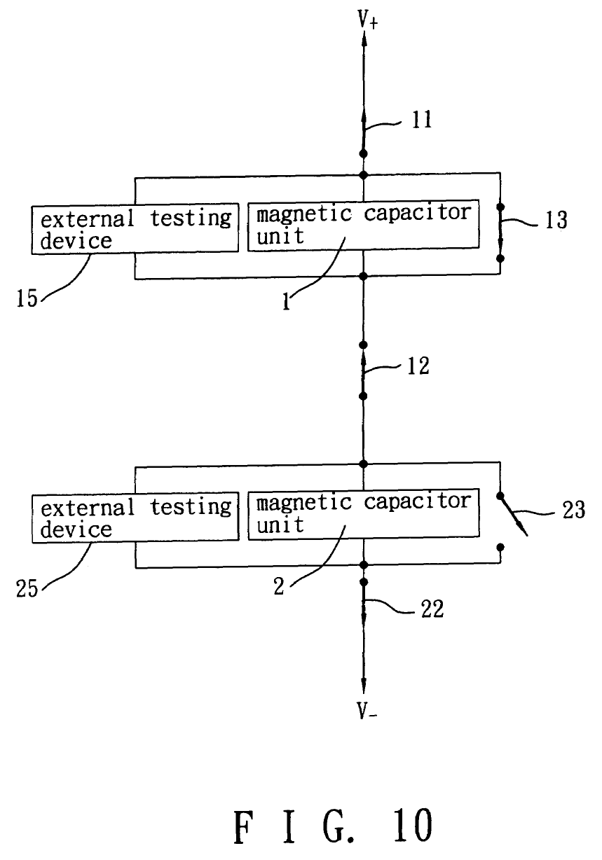

Referring to FIG. 10, the third preferred embodiment of a fault protection device according to this invention is shown to be similar to the second preferred embodiment except that there is only one switch 12 between two magnetic capacitor units 1, 2 in a series connection relationship.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A fault protection device, comprising:
a magnetic capacitor unit capable of storing electrical energy, and having a first end and a second end; and
an isolation switch capable of being switched on to electrically connect said first end of said magnetic capacitor unit to said second end of said magnetic capacitor unit for forming a short-circuit path between said first and second ends of said magnetic capacitor unit when said magnetic capacitor unit breaks down.

2. The fault protection device as claimed in claim 1, wherein said isolation switch is switched off when said magnetic capacitor unit has yet to break down while said fault protection device operates in a working mode.

3. The fault protection device as claimed in claim 1, further comprising a first switch capable of being switched on to electrically connect said first end of said magnetic capacitor unit to a first node, and a second switch capable of being switched on to electrically connect said second end of said magnetic capacitor unit to a second node.

4. The fault protection device as claimed in claim 3, wherein said first and second switches are switched on when said fault protection device operates in a working mode.

5. The fault protection device as claimed in claim 3, wherein said isolation switch, said first switch, and said second switch are switched off when said fault protection device operates in a testing mode in which said first and second ends of said magnetic capacitor unit receive a testing signal for testing breakdown of said magnetic capacitor unit.

6. The fault protection device as claimed in claim 1, wherein said magnetic capacitor unit includes at least one magnetic capacitor.

7. The fault protection device as claimed in claim 6, wherein said magnetic capacitor includes a first magnetic electrode, a second magnetic electrode, and a dielectric layer disposed between said first and second magnetic electrodes.

8. The fault protection device as claimed in claim 7, wherein said first and second magnetic electrodes are magnetized to have magnetic dipoles arranged in such a manner to reduce current leakage of said magnetic capacitor.

9. The fault protection device as claimed in claim 7, wherein said first magnetic electrode includes a first magnetic layer, a second magnetic layer, and an insulator layer made of a non-magnetic material and disposed between said first and second magnetic layers of said first magnetic electrode.

10. The fault protection device as claimed in claim 9, wherein said first magnetic layer has magnetic dipoles arranged in a first direction, and said second magnetic layer has magnetic dipoles arranged in a second direction opposite to the first direction.

11. The fault protection device as claimed in claim 7, wherein each of said first and second magnetic electrodes includes a rare earth element.

12. The fault protection device as claimed in claim 7, wherein said dielectric layer includes a material selected from a group consisting of titanium oxide, barium titanate, and a semiconductor material.

13. The fault protection device as claimed in claim 12, wherein said semiconductor material is silicon oxide.

14. The fault protection device as claimed in claim 6, wherein said magnetic capacitor unit includes a plurality of said magnetic capacitors having one of a series connection relationship, a parallel connection relationship, and a series-parallel connection relationship.

15. A fault protection device, comprising:
a magnetic capacitor unit capable of storing electrical energy, and having a first end and a second end; and
an isolation switch capable of being switched on to electrically connect said first end of said magnetic capacitor unit to said second end of said magnetic capacitor unit,
wherein said isolation switch is switched off when said fault protection device operates in a testing mode in which said first and second ends of said magnetic capacitor unit receive a testing signal for testing breakdown of said magnetic capacitor unit.

16. The fault protection device as claimed in claim 15, wherein a result signal is obtained from each of said first and second ends of said magnetic capacitor unit and is used to determine whether said magnetic capacitor unit has broken down when said fault protection device operates in the testing mode.

17. The fault protection device as claimed in claim 15, wherein said magnetic capacitor unit includes at least one magnetic capacitor.

18. The fault protection device as claimed in claim 17, wherein said magnetic capacitor unit includes a plurality of said magnetic capacitors having one of a series connection relationship, a parallel connection relationship, and a series-parallel connection relationship.
